(19) United States
(12) Patent Application Publication
(10) Pub. No.: US 2012/0205404 A1
(43) Pub. Date: Aug. 16, 2012

(54) Tube head provided with an air non-return valve

(75) Inventors: Jean-Manuel Massey, Prunay (FR); Eric Kerman, Chalon En Champagne (FR); Nick Thorne, Seyssins (FR)

(73) Assignee: ALCAN PACKAGING BEAUTY SERVICES, Gennevilliers (FR)

(21) Appl. No.: 13/028,951

(22) Filed: Feb. 16, 2011

(51) Int. Cl. B65D 35/38; B65D 35/00; B67D 1/00

(52) U.S. Cl. 222/494; 222/80; 222/107

(57) ABSTRACT

The present invention relates to a tube head for product of fluid to pasty consistency comprising:
a neck having at a first end an opening through which the product is extracted from the tube; and
a shoulder connected to a second end of the neck opposite the first end, and the tube head comprising an air non-return means placed in said neck, said means being adapted to avoid a return of air from the first end of the neck to the second end of the neck, characterised in that the tube head is one piece and in that the non-return means comprise at least one valve.

### GENERAL TECHNICAL FIELD

The invention relates to a tube head for product of fluid to pasty consistency, and in particular to a tube head comprising an air non-return system.

### STATE OF THE PRIOR ART

A tube may contain a product of fluid to pasty consistency reactive in contact with air (toothpaste, foundation, sun cream, adhesive, paint, medicine, etc.). Indeed, certain products can undergo oxidation on contact with air and thereby lose their chemical properties.

The bringing of air into contact with the product takes place once the protective lid at the opening of the tube head is removed. During use of the product, the user presses the skirt of the tube in order to expel the product out of the tube via the opening of the head. This opening is formed at the end of a neck constituting the head with a shoulder broadening out from the neck. Thus, the product is present inside the neck at the moment when the user reduces the pressure exerted on the tube.

When the user has extracted sufficient product from the tube for use and releases the skirt, the pressure exerted on the skirt of the tube is reduced. Generally, the physical properties of the skirt of the tube have a more or less elastic character, which implies that the skirt recovers, at least partially, its initial shape (shape before the application of the pressure by the user) and induces a return of the product contained in the head.

If this elastic recovery of the skirt is small, a part of the product inside the neck is sucked towards the shoulder. The part of the product remaining inside the neck ensures a plugging of the neck vis-à-vis external air. Since the neck has a relatively low internal volume, of the order of several mm³, compared to the internal volume of the shoulder or the skirt, this implies that a very small quantity of external air is present in the tube at the neck and that a very small quantity of product is in contact with the air.

However, if this elastic recovery is important, all of the product present in the neck can return to the shoulder until the neck is completely empty. Consequently, the whole neck as well as a portion of the shoulder, or even all of the shoulder, receives external air through suction, which considerably increases the volume of air housed inside the tube and significantly increases the aforementioned risks of oxidation of the product contained in the tube.

If the cap of the tube is then closed, the oxygen from the air sucked into the tube after its use is going to be able to react with the product contained in the tube, and does so up to the next use, potentially several hours, days or even weeks later. Moreover, if the product has to be applied to the skin of a user, a risk of bacterial contamination of the product exists on account of the contact of the product with the external air sucked in.

This situation is avoided by placing an air non-return system inside the tube. Such a system prevents a return of air inside the tube. An example of such system is illustrated by the document WO03/016159.

This document indeed describes a tube head, comprising a neck and a shoulder extending from the neck. In order to prevent a return of air inside the tube, an insert comprising a valve and means of pressuring said valve is placed in the neck.

The problem of such a system is its structural and industrialisation complexity as well as its cost. In this respect, such a system comprises several components different to each other that need to be assembled together. On the one hand, each component is manufactured separately, which increases the total cost of the system. Then, the assembly of the components together is particularly difficult given that it takes place in the tube head, the head only having available very little space, of the order of a millimetre, to accommodate said system. On the other hand, placing said system inside the head necessitates a high degree of manufacturing precision given that a certain sealing needs to be respected to avoid said return of air. This precision also leads to a production cost.

### DESCRIPTION OF THE INVENTION

The invention aims to present a tube head not having these drawbacks.

The invention thus proposes a tube head for product of fluid to pasty consistency comprising
a neck having at a first end an opening through which the product is extracted from the tube,
a shoulder connected to a second end of the neck opposite the first end, and the tube head comprising an air non-return means placed in said neck, said means being adapted to avoid a return of air from the first end of the neck to the second end of the neck, characterised in that the tube head is one piece and in that the non-return means comprise at least one valve.

According to several variants, the tube head may comprise one or more of the following characteristics, taken independently or in combination:
the non-return valve is placed at the second end of the neck;
the non-return valve is placed at an intermediate position between the first and the second end of the neck, so that for a valve having a maximum dimension D, the distance between said valve and the first end of the neck is greater than or equal to D;
the valve is placed in a plane substantially perpendicular to the axis of the neck;
the tube head comprises a hinge connecting the non-return valve to an internal face of the neck by the hinge so that the valve is moveable in rotation;
the neck comprises an internal face of substantially cylindrical shape, having a lip to which is connected said non-return valve;
the non-return means are formed of several valves, the set of said valves being adapted to plug a channel of the neck, said valves being typically identical;
the tube head is made of plastic material, such as polyethylene or polypropylene.

The invention also relates to a tube comprising such a tube head.

According to a particular embodiment, the tube comprises a skirt made of at least one plastic material, the skirt typically having at least one of the following properties:
a thickness between 150 and 250 μm; more specifically between 225 and 235 μm; typically of the order of 230 μm;
a diameter between 1 and 8 cm; for example between 2 and 5 cm;
a length between 5 and 20 cm, for example between 8 and 16 cm, typically of the order of 15 cm.

The invention also relates to a method of manufacturing a tube head, said method comprising the following steps:
a step of injection of the tube head, so as to form a neck having an opening at a first end, a shoulder connected to a second end of the neck opposite the first end, and a membrane placed in said neck, so as to block it, the tube head being monolithic,
a step of punching of said membrane, so as to cut said membrane in order to form at least one valve placed inside the neck.

According to a particular embodiment, the step of punching is carried out by application of a punch on said membrane, so as to form the valve and a hinge connecting the valve to the neck.

According to a variant of this method, the neck and the shoulder are made of a first plastic material, the air non-return means being formed by injection moulding of a second plastic material different to the first plastic material.

### DESCRIPTION OF FIGURES

Other characteristics, aims and advantages of the invention will become clear from the description that follows, which is purely illustrative and non limiting, and which should be read with reference to the appended drawings, in which:

FIGS. 1, 2 and 3 present several views of a tube head according to an embodiment of the invention;

FIGS. 4, 5 and 6 present views of another embodiment of the tube head;

FIG. 7 illustrates a variant of this embodiment;

FIG. 8 illustrates a sectional view of the tube head presented previously in FIGS. 1 to 3, on which is placed a cap;

FIGS. 9a to 9f present several examples of punches used to form the tube head;

FIG. 10 illustrates an example of shaping of the air non-return means by means of a punch;

FIG. 11 illustrates another variant of the tube head, in which the neck comprises a double wall.

In all of the figures, identical or similar components are marked with identical references.

### DETAILED DESCRIPTION

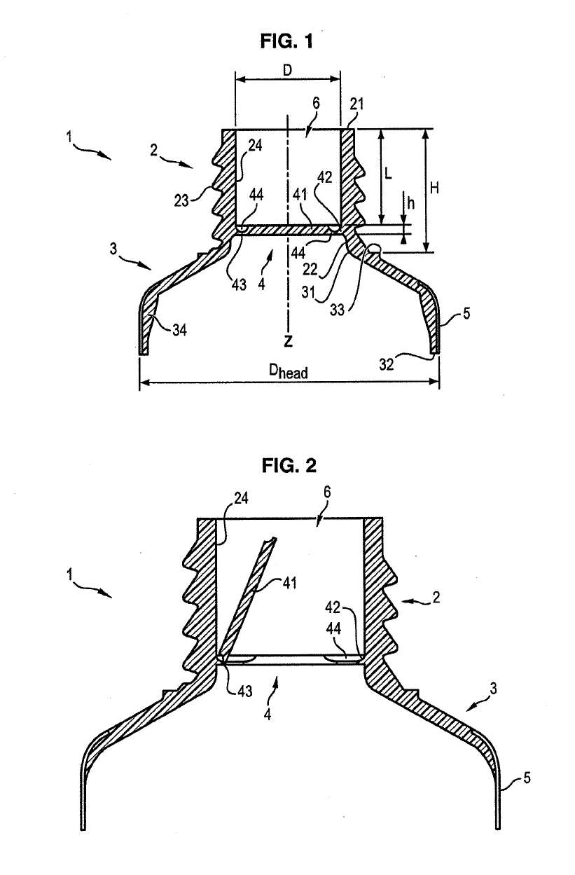

FIGS. 1, 2 and 3 present several views of a tube head according to an embodiment of the invention.

The head 1 comprises:
a neck 2,
a shoulder 3, and
non-return means 4.

The tube head 1 is connected to a body by a skirt 5, a part of which connected to one end of the shoulder 3 is represented.

The body of tube 5 delimits one or more reservoirs of products.

The neck 2 comprises a first end 21 provided with an opening 6 defined by an internal face 24 of the neck 2, and a second end 22 opposite to said first end 21, at which the neck 2 is connected to the shoulder 3.

The neck 2 is conventionally substantially cylindrical, elliptical or conical around an axis Z, so as to enable the closing of the opening 6 via a cap, not represented, which is screwed onto an external threading 23 of the neck 2. The axis Z corresponds to an axis of symmetry of the internal face 24 of the neck 2.

Other embodiments may be envisaged, especially embodiments in which the tube head 1 comprises a cap commonly called “flip-top” provided with a pivoting cover. The cap is then typically screwed, bonded, welded or force fitted onto the tube head 1, in a position oriented in an adapted manner as a function of the shape of the tube and any inscriptions borne on it. FIG. 11, which will be presented later, illustrates this embodiment.

As represented in FIG. 1, the first end 21 of the neck 2 is substantially flat, so as to enable a sealed joint to be formed between the neck 2 and a cap screwed onto said neck 2.

In a variant, a sealing joint may be placed on said first end 21 of the neck.

The shoulder 3 as illustrated extends from the second end 22 of the neck 2, and is splayed from one joint end 31 of the shoulder 3 to a free end 32 of the shoulder 3.

In a variant, the shoulder 3 is substantially flat. The shoulder 3 extends for example from the second end 22 of the neck 2 in a plane perpendicular to the axis Z of the neck 2.

In the embodiment illustrated, the shoulder 3 comprises a stop 33 placed near to its neck end 31, said stop 33 making it possible to form a stop when a cap is screwed onto the neck 2.

This stop 33 thus makes it possible to reinforce the area of the shoulder 3 on which a force is likely to be exerted during the screwing down onto the neck.

The stop 33 typically has a profile comprising one or more circular lips, or is composed of several portions of circle centred on the axis Z of the neck 2.

The shoulder 3 typically comprises a reinforced section 34 at the joint between the tube head 1 and the skirt 5, taking the shape of a section of thickness substantially increased in the embodiment represented in FIG. 1.

The non-return means 4 as represented are an air non-return valve placed inside the neck 2.

In the embodiment represented, the means 4 are placed in a plane substantially perpendicular to the axis Z of the neck 2, and are adapted to make it possible to plug substantially entirely the channel formed in the neck 2 delimited by its internal face, and ending by the opening 6.

The air non-return means 4 comprise at least one valve 41 that is typically connected to the internal face of the neck 2 via a lip 42 extending over the whole periphery of the neck 2.

The air non-return means 4 are advantageously connected to this lip 42 via a hinge 43, formed by a bridge of material between the lip 42 and the valve 41.

The air non-return means 4 moreover comprise a circular groove 44 at the joint between the lip 42 and the valve 41.

As will be explained hereafter, the valve 41 is typically formed by the cutting of a membrane placed inside the neck 2 by means of a punch, or formed directly during the manufacture of the tube head 1.

The following values may be noted in FIG. 1:
D: corresponds to the diameter of the opening 6, in other words to the internal diameter of the neck 2;
H; corresponds to the height of the neck 2, in other words the distance between the first end 21 and the second end 22;
Dhead; corresponds to the maximum diameter of the tube head 1, in other words the diameter of the tube head at its joint with the tube body 5;
h; corresponds to the thickness of the air non-return means 4;
L; corresponds to the distance between the first end 21 of the neck 2 and the air non-return means 4.

In particular embodiments, the head 1 has measurements lying within the following ranges of values:
D is between 5 and 10 mm; typically of the order of 5.66 mm or 9.1 mm;
H is between 5 and 10 mm, typically between 8 and 10 mm;
Dhead is between 20 and 30 mm; typically of the order of 25 or 30 mm;
h is between 0.5 and 1.5 mm; typically of the order of 0.75 or 1 mm;
L is between 6 and 12 mm; typically of the order of 8 mm.

FIG. 2 illustrates the tube head 1 presented previously in a configuration in which the valve 41 is open.

The joint between the valve 41 and the lip 42 is formed by means of the hinge 43.

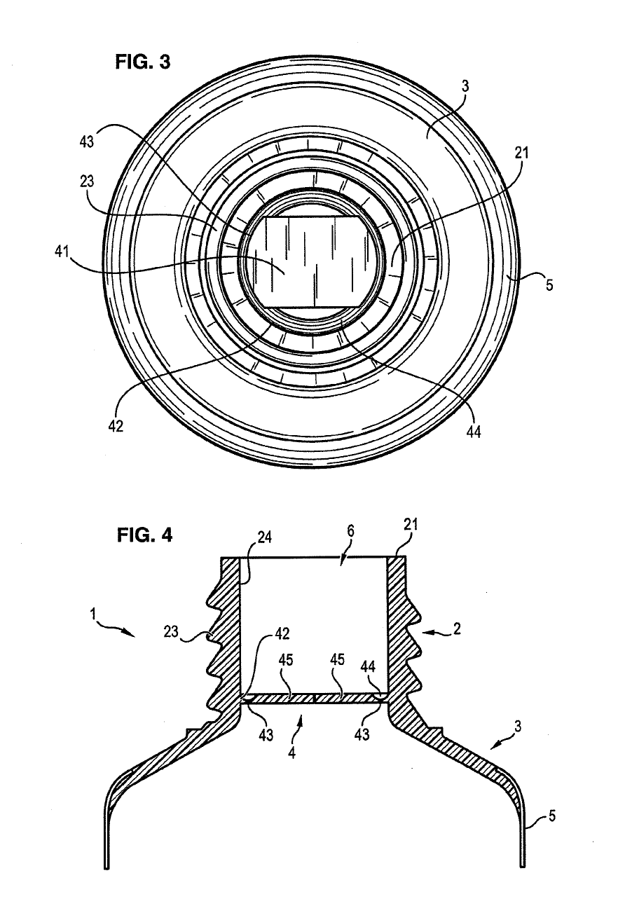

FIG. 3 portrays a top view of the tube head 1, and thus illustrates the shape of the valve 41 according to a particular embodiment of the invention.

The valve 41 here has a shape of truncated disc or rectangle having two rounded opposite sides. The hinge 43 is advantageously placed at one of said rounded ends of the valve 41, the truncated sides enabling the valve not to bump into the internal face 24 of the neck 2 when it moves into open position as illustrated in FIG. 2.

The hinge 43 may extend over all or part of one of the rounded sides of the valve 41, as a function of the mechanical properties of the material from which is constituted the tube head 1. A cut is made in order to separate the lip 42 from the valve 41, except at the hinge 43, which is thus composed of a bridge of material between the valve 41 and the lip 42.

As illustrated in FIG. 3, the cut is made substantially in the central part of the gorge 44, in other words at the area of minimal thickness of the valve 4. The hinge is thus also situated at said area of minimal thickness, which makes it possible to reduce the force required to open the valve 41.

Moreover, the cut is thus slightly distant from the internal face 24 of the neck 2, which is advantageous for the machining of the cut.

It will be noted that the lip 42 creates an offset; this enables the valve 41 to move into open position without its movement being hindered by the internal face 24 of the neck 2.

FIGS. 4, 5 and 6 present views of another embodiment of the tube head, in which the air non-return means 4 comprise several valves 45, each of said valves here having a shape of portion of disc.

Only the differences with the embodiment presented in FIGS. 1 to 3 will be described here, the components in common being marked by the same numerical references.

In this embodiment, the air non-return means 4 comprise several valves 45, each of said valves 45 being connected individually to the lip 42 by means of a hinge 43.

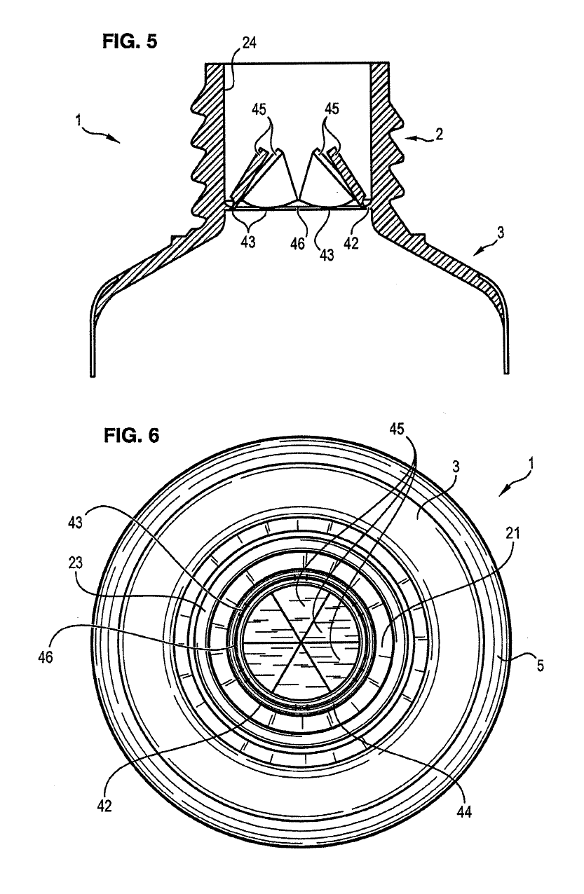

FIG. 4 presents the air non-return means 4 in closed position, whereas FIG. 5 portrays the air non-return means 4 in open position.

FIG. 5 illustrate more precisely the valves 45 in a position where they enable an important passage of product through the neck 2, and are inclined at an important angle in relation to their closed position.

This high inclination of the valves 45 is here possible on account of the dimensions of the hinge 43, which only extends over part of the rounded edge 46 of the valves 45. The hinges 43 as represented thus have a relatively low strength, and enable an important opening of the valves 45 when the user exerts a pressure on the skirt 5 of the tube.

FIG. 6 portrays a top view of the tube head 1, and thus illustrates the arrangement of the valves 45, which here have the shape of portions of discs connected to the lip 42 by a hinge 43 placed at their rounded edge 46.

The hinges 43 may extend over all or part of the edge of the valves adjacent to the lip 42, the extent of the hinge defining its plastic deformation strength as explained previously; it is typically defined as a function of the material from which the tube head 1 is formed.

In the embodiment illustrated in FIG. 6, the air non-return means 4 comprise six valves 45, each of said valves 45 corresponding to a portion of disc of around 60° so that the set of said valves 45 blocks the channel of the neck 2. As illustrated, each of the parts of valves 45 is connected to the lip 42 by a hinge 43 extending over the whole rounded part of the valves 45.

The valves 45 are typically identical.

The hinges 43 may be modified, in order to extend over all or part of the rounded part of the valves 45, the dimensions of the hinges being typically determined as a function of the material from which is formed the tube head 1, and especially its elastic properties.

During use of the tube, the user compresses the skirt 5 of the tube in order to extract thereof the product that it contains.

The product present in the skirt 5 of the tube is then directed towards the tube head 1, and exerts an effort on the air non-return means 4.

Under the force exerted by the thrust of the product, the valve 41 of the air non-return means 4 or, in the embodiment illustrated, the valves 45 are driven in rotation via the hinge 43: the valve 41 then moves in rotation, its end opposite the hinge going in the direction of the opening 6, and thus enables the product to come out of the tube through the opening 6 of the neck 2 through the air non-return means 4.

When the user ceases exerting a compressive force on the skirt 5 of the tube, it undergoes an elastic recovery to its initial shape, said elastic recovery being more or less important as a function of the material from which the skirt 5 of the tube is constituted.

The skirt 5 of the tube is for example composed of all or part of the following materials: polyethylene especially in its high, medium and low density variants, of a metal sheet.

The following embodiments may especially be distinguished:
the skirt 5 is made of polyethylene, comprising or not a metal sheet such as aluminium, and the tube head 1 is made of polyethylene and the air non-return means are also made of polyethylene or overmoulded in another material;
the skirt 5 is made of polypropylene comprising or not a metal sheet such as aluminium and the tube head 1 is made of polyethylene and the air non-return means are also made of polypropylene or overmoulded in another material.

The skirt 5 typically has the following dimensions:
a thickness between 150 and 250 μm; more specifically between 200 and 250 μm, for example between 225 and 235 μm; typically of the order of 230 μm;
a diameter between 1 and 8 cm; for example between 2 and 5 cm;
a length between 5 and 20 cm, for example between 8 and 16 cm, typically of the order of 10 to 12 cm.

A skirt 5 having such characteristics has a low elastic recovery after its compression by the user, and thus makes it possible to optimise the air non-return effect in combination with the air non-return means 4.

High density polyethylene (HDPE) is defined by a density greater than or equal to 0.941 g/cm3. HDPE has a low degree of branching, and thus strong intermolecular forces, and a high tensile strength.

Medium density polyethylene (MDPE) is defined by a density between 0.926 and 0.940 g/cm3.

Linear low density polyethylene (LLDPE) is defined by a density between 0.915 and 0.925 g/cm3. LLDPE is a substantially linear polymer, with a high number of short branches, which is normally formed by copolymerisation of ethylene with short chain alpha-olefins (for example 1-butene, 1-hexane or 1-octene).

Low density polyethylene (LDPE) is defined by a density between 0.910 and 0.925 g/cm3. LDPE has a high level of branching of short and long chains, which implies that the chains are not well contained in the crystalline structure, and results in a lower tensile strength and a more ductile material.

Very low density polyethylene (VLDPE) is defined by a density between 0.880 and 0.915 g/cm³.

The methods for producing these different types of polyethylene are well known from the prior art.

This elastic recovery leads to a backward movement of the product located in the neck 2, which is sucked towards the inside of the skirt 5 of the tube.

The presence of the air non-return means 4 makes it possible to plug the neck 2 following the use of the tube, and thus to make it possible to preserve the product that it contains from degradations by the external environment.

Indeed, during the suction of the product towards the inside of the tube, the valve 41 or the valves 45 of the valve 4 repositions itself or reposition themselves in closed position, under the action of the elastic recovery of the hinge 43, and thus prevent air or contaminants penetrating into the tube and contaminating the product that it contains.

The air non-return means 4 are advantageously positioned inside the neck 2 so that during the rotational movement of the valve 41 they remain entirely in the neck 2 without coming out of it in order not to hinder the user. In a more general manner, the air non-return means 4 are advantageously positioned so as to not to jut out from the opening 6.

Thus, the air non-return means 4 are advantageously placed in the neck 2 at a distance from its first end 21 greater than or equal to the maximum dimension of the valve 41 or valves 45.

The embodiments comprising several valves 45 of reduced dimensions thus make it possible to position the air non-return means 4 nearer the first end 21 of the neck 2, in so far as the amplitude of movement of said valves 45 is smaller than in the case of a single valve 41 plugging the channel of a neck 2 of same dimensions.

In addition, a higher number of parts of valve 45 makes it possible to facilitate the opening of the valve 41 and thus the outflow of the product under the action of the user.

More specifically, in the case where the hinge 43 extends over the whole edge of the valves 45 in contact with the lip 42 or the inside of the neck 2, increasing the number of valve parts 45 makes it possible to reduce the dimensions and thus the mechanical strength of the hinge, and thereby facilitate the elastic deformation thereof to enable the product to come out of the tube.

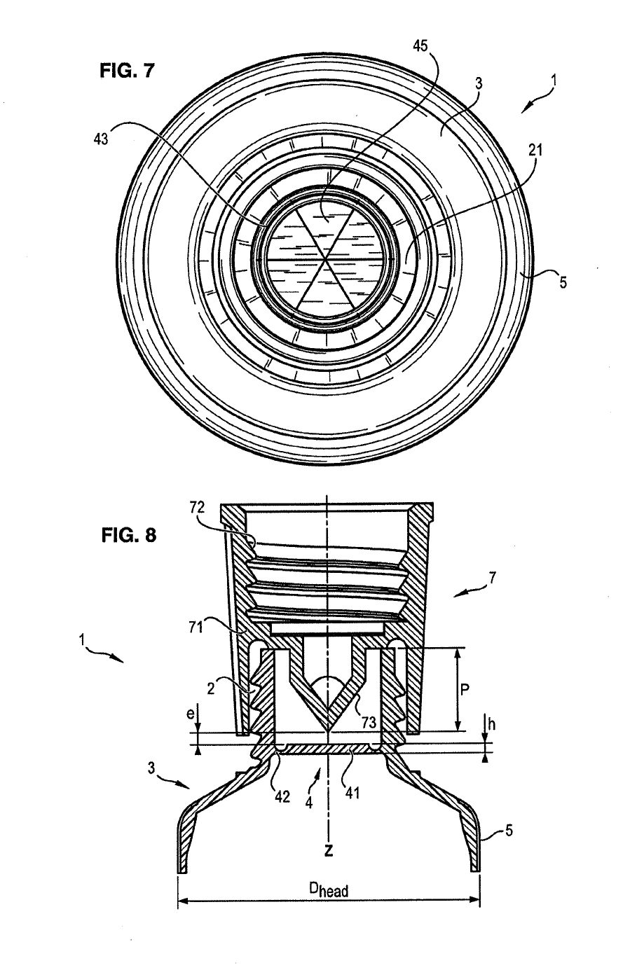

FIG. 7 presents a variant of the tube head 1 presented in FIGS. 4, 5 and 6, in which the hinges 43 of the valves 45 extend over the whole rounded edge of the valves 45.

In this particular configuration, the hinges 43 have a mechanical strength much higher than the configuration presented in FIGS. 4 to 6, in which the hinges 43 are of reduced dimensions.

The greater the dimensions of the hinge 43, and especially in terms of length along the rounded edge of the valve or valves 41 or 45, the greater its mechanical strength, and thus the less the valve or valves 41 or 45 will move.

In the case where the hinge 43 has a low mechanical strength, the valve or valves 41 or 45 pivot easily under the effect of the thrust of product when the user exerts a pressure on the skirt 5 of the tube.

In the case where the hinge 43 has a high mechanical strength, the valve or valves 41 or 45 pivot very slightly, and only the free end of the valve or valves 41 or 45 then moves in order to enable the product contained in the tube to pass via the channel of the neck 2.

According to another variant, the air non-return means 4 comprise a membrane extending over the whole internal section of the neck 2, and provided with a slit extending along a diameter of the neck 2, said slit widening by elastic deformation of the material in order to enable the passage of the product when the user exerts a pressure on the tube, then recovering its initial position in which it plugs the neck 2.

FIG. 8 illustrate a sectional view of the tube head 1 presented previously in FIGS. 1 to 3, on which is placed a cap 7.

The cap 7 typically comprises a substantially cylindrical or conical body 71, a tapping 72 complementary to the threading 23 of the neck 2 and a piercing tip 73, arranged so that the cap can be screwed onto the neck 2 when it is brought onto the neck 2 via a first end, and so that the piercing tip 73 is inserted inside the neck 2 when the cap 7 is brought onto the neck 2 via a second end opposite to said first end.

As illustrated in FIG. 8, the cap 7 is placed on the neck 2 so that the piercing tip 73 is positioned inside the neck 2, such a configuration being typically employed during the first use of the tube in order to pierce a packaging lid placed on the end of the neck 2 and plugging it in a hermetic manner in order to protect the product that it contains.

FIG. 8 illustrates the positioning of the air non-return means 4 inside the neck 2;

these are placed at a sufficient distance from the first end 21 of the neck 2 to enable the piercing tip 73 not to enter into contact with the air non-return means 4 when the cap 7 is thus positioned on the neck 2.

Thus, for a piercing tip 73 having a height P, the air non-return means 4 are placed at a distance P+e from the first end 21 of the neck 2, where e is equal to the minimum gap desired between the air non-return means 4 and the piercing tip 73.

In particular embodiments, P is between 5 and 8 mm, typically equal to 7.3 mm, and e is between 0.5 and 2 mm, typically equal to 0.5 or 1.9 mm.

The tube head 1 and the skirt 5 of the tube may be formed according to several methods.

The tube head 1 is typically formed by injection of plastic material, for example polyethylene or polypropylene. In a variant, the tube head 1 may also be formed by a material compression method.

The skirt 5 may also be formed by extrusion of plastic material (then known as plastic skirt) or by longitudinal winding and welding of a multi-layer material made of polyethylene, polypropylene or a mixture of polyethylene and polypropylene, having or not a metal sheet (then known as metallo-plastic skirt). Such a metallo-plastic structure corresponds to a layer of metallic material such as aluminium, covered with one or more layers of plastic materials.

The tube head 1 is then for example
either directly overmoulded on the skirt 5, this operation of overmoulding being advantageously carried out directly after the formation of the skirt 5, for example on a same production site or on a same production line;
or formed independently of the skirt 5, then assembled on the skirt 5, typically by welding or bonding.

During the manufacture of the tube head 1, the air non-return means 4 are formed like an internal membrane at the neck 2, which is then machined in order to define the valve 41 and the hinge 43, for example by punching.

The tube head 1 is thus monolithic; it is formed in a single piece and thus does not necessitate additional steps of positioning the different components in relation to each other.

The neck 2, the shoulder 3 and the air non-return means 4 form a one piece unit. The one piece, or monolithic, character of the tube head 1 does not imply that the latter is formed of a single material. For example, the shoulder 3 and the neck 3 may be formed of polyethylene, and the air non-return means of elastomeric material. In this case, the tube head 1 forms a one piece unit constituted of two chemically different materials, linked by chemical bonding without requiring mechanical assembly or joint.

The air non-return means 4 are then typically formed by injection moulding.

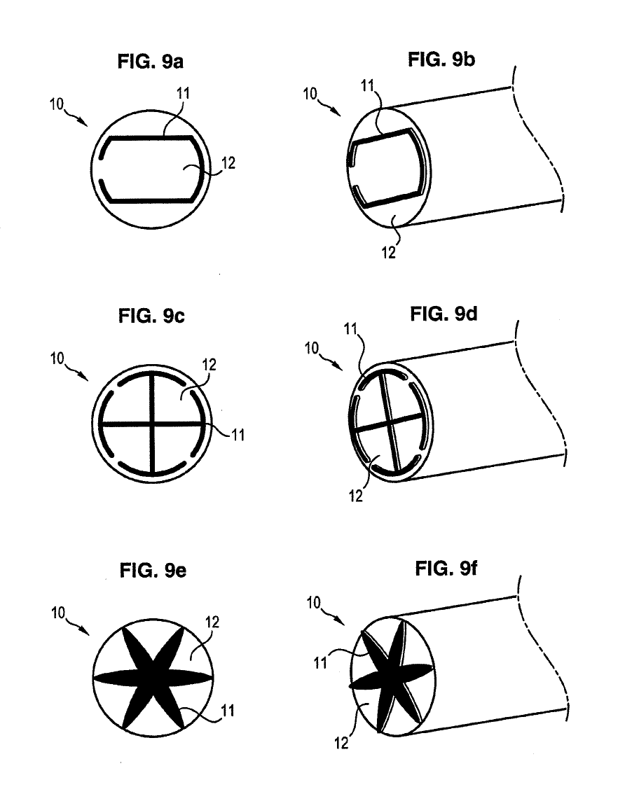

FIGS. 9a to 9f present several examples of punch used for the formation of the valve 4 of the tube head 1.

FIGS. 9a and 9b illustrate two views of a punch 10 used to form an air non-return means 4 comprising a single valve 41 and provided with a hinge 43, corresponding for example to the embodiment illustrated in FIGS. 1 to 3.

The punch 10 as represented has a cylindrical shape, and is thereby adapted to be inserted and guided in translation inside the neck 2. In an advantageous manner, the external diameter of the punch 10 corresponds to the internal diameter of the neck 2, so as to ensure said guiding in translation.

The punch 10 comprises a raised cutting component 11 placed on an upper flat surface 12, making it possible to define the valve 41 or the parts of valve 45.

FIGS. 9c and 9d present two views of the punch 10 making it possible to form a valve 41 comprising four valve parts 45, each of said valve parts having a hinge 43 extending over a reduced part of its external periphery. In the same way as in FIGS. 9a and 9b, the punch 10 here comprises a flat upper surface 12 on which is placed a raised cutting component 11.

FIGS. 9e and 9f present two views of a punch 10 adapted to form an air non-return means 41 comprising six valves 45. In this particular embodiment, the punch has a substantially conical upper surface 12, on which is placed the raised cutting component 11 on this upper conical surface 12.

The punch 10 is advantageously inserted into the tube head via the end opposite to the neck 2, which makes it possible to facilitate the subsequent rotation of the valve 41 or the parts of valve 45 towards the opening 6 of the neck 2, by orienting them substantially in the direction of the opening 6 of the neck 2.

The punch 10 illustrated in FIGS. 9e and 9f makes it possible to accentuate this effect, by realising an initial deformation of the valve 41 or valve parts 45 in direction of the opening 6 of the neck 2.

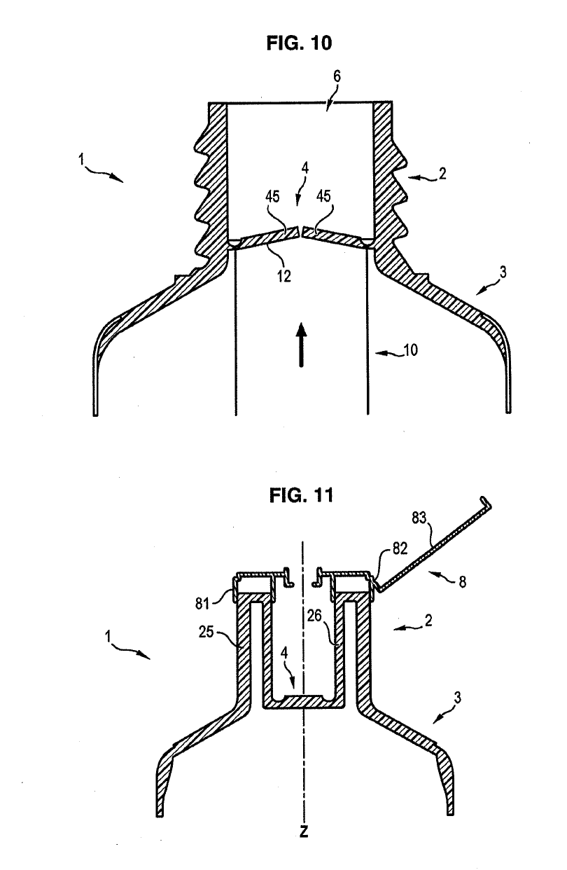

FIG. 10 illustrates the insertion of a punch 10 similar to that presented in FIGS. 9e and 9f in a tube head 1, in order to form the valves 45 from a membrane blocking the channel of the neck 2.

This figure illustrates especially the fact that the inclined upper face 12 of the punch 10 makes it possible to form the valves 45 in a configuration similar to their position in which they enable a passage of product into the channel of the neck 2.

It may be observed moreover that the punch presented in these FIGS. 9e and 9f makes it possible to form valves 45 comprising a hinge extending over the whole of the rounded side, unlike the punches presented in FIGS. 9a to 9d in which the cutting components clearly define a hinge of reduced dimensions.

FIG. 11 illustrate another variant of the tube head 1, in which the neck 2 portrays a structure comprising two walls 25 and 26.

This variant comprises several components in common with the variants presented previously, which will not be detailed again here.

In this variant, the neck 2 has an external wall 25 and an internal wall 26, between which is defined an internal space 27.

The external wall 25 and the internal wall 26 are typically concentric, centred on the axis Z of the neck 2.

In the embodiment represented in FIG. 11, the tube head 1 is associated with a flip-top type cap 8. The cap 8 as represented comprises a base 81 that is assembled on the first end 21 of the neck, for example screwed, bonded, welded or force fitted, a hinge 82 and a lid 83, connected to the base 81 via the hinge 82. The base 81 of the cap 8 and the neck 2 of the tube head 1 then comprise complementary ratchet means.

In this particular embodiment, the neck 2 does not then necessarily comprise threading 23 as in the embodiments presented in the preceding figures. It will be easily understood that this structure of the tube head 1 comprising an external wall 25 and an internal wall 26 may also be associated with a cap that is screwed onto the neck 2, which then comprises a threading at the external face of its external wall 25.

The external wall 25 comprises the threading 23 on its external face, and has an external face that is typically cylindrical or conical.

The internal wall 26 is typically tubular or conical, of axis Z identical to the axis of the neck 2, and is connected to the external wall 25 via the first end 21 of the neck 2.

The internal wall 26 defines the dimensions of the opening 6 of the neck; typically its diameter in the case of a cylindrical or conical opening 6. The air non-return means 4 are connected to the internal wall 26, and thus partially block the opening 6.

The thickness of the internal wall 25 is typically between 0.5 and 1 mm; for example equal to 0.75 mm.

The height of the internal wall 25, which corresponds typically to the distance between the air non-return means 4 and the opening 6 of the tube head 2, is typically between 5 and 10 mm, for example equal to 9.2 mm.

This variant is especially advantageous in terms of manufacture.

The invention thus makes it possible to form a tube head 1 comprising air non-return means 4 formed of the same material as the tube head 1, and making it possible to preserve the product contained in the tube associated with the tube head 1 without requiring complex and costly manufacturing steps.

1. Tube head for product of fluid to pasty consistency comprising
a neck having at a first end an opening, the opening configured to allow product to be extracted from the tube through the opening,
a shoulder connected to a second end of the neck opposite the first end, and
the tube head comprising an air non-return means placed in said neck, said means being adapted to avoid a return of air from the first end of the neck to the second end of the neck, characterised in that the tube head is one piece and in that the non-return means comprise at least one valve.

2. Tube head according to claim 1, wherein the at least one valve is placed at the second end of the neck.

3. Tube head according to claim 1, wherein the at least one valve is placed at an intermediate position between the first and the second end of the neck so that, for a valve having a maximum dimension D, the distance between said valve and the first end of the neck is greater than or equal to D.

4. Tube head according to claim 1, wherein the at least one valve is placed in a plane substantially perpendicular to an axis of the neck.

5. Tube head according to claim 1, comprising a hinge connecting the at least one valve to an internal face of the neck by the hinge so that the valve is moveable in rotation.

6. Tube head according to claim 1, wherein the neck comprises an internal face of substantially cylindrical shape, having a lip to which is connected said at least one valve.

7. Tube head according claim 1, wherein the non-return means are formed of a set of several valves, the set of said valves being adapted to plug a channel of the neck.

8. Tube head according to the claim 7, wherein each of the several valves within the set of said valves are identical.

9. Tube head according to claim 1, wherein the neck comprises an internal wall and an external wall, said walls being concentric and separated from one another by an internal housing, and connected to the first end of the neck, the air non-return means being connected to the internal wall of the neck.

10. Tube head according to claim 1, characterised in that the tube head is made of at least one plastic material.

11. Tube for product of fluid to pasty consistency comprising the tube head according to claim 1.

12. Tube according to claim 11, further comprising a skirt made of at least one plastic or metallo-plastic material.

13. Tube according to claim 12, wherein the skirt has at least one of the following properties:
a thickness between 150 and 250 μm;
a diameter between 1 and 8 cm; and
a length between 5 and 20 cm.

14. Method of manufacturing a tube head, said method comprising
injecting the tube head, so as to form a neck having an opening at a first end of the neck, a shoulder connected to a second end of the neck opposite the first end, and a membrane placed in said neck, so as to plug the neck, the tube head being monolithic,
punching said membrane, so as to cut said membrane in order to form at least one air non-return means placed inside the neck.

15. Method according to claim 14, wherein the step of punching is carried out by application of a punch on said membrane, so as to form a valve and a hinge connecting the valve to the neck.

16. Method according to claim 14, wherein the neck and the shoulder are made of a first plastic material, the at least one air non-return means being formed by injection moulding of a second plastic material different to the first plastic material.
